(19) United States
(12) Patent Application Publication
(10) Pub. No.: US 2013/0123676 A1
(43) Pub. Date: May 16, 2013

(54) Device and method for self-applying back massage

(71) Applicant: Margot Fallstich, Edison, NJ (US)

(72) Inventor: Margot Fallstich, Edison, NJ (US)

(21) Appl. No.: 13/373,537

(22) Filed: Nov. 16, 2011

(51) Int. Cl. A61H 15/00

(52) U.S. Cl. 601/118

(57) ABSTRACT

A device easily handled by a user to self-massage the user's back using any existing flat surface such as a wall and the weight and motion of the users's body. The device uses two holding straps for the user's hands attached to a firm metal rod with two or more semi-compressible “bouncy balls” that rotate with the rod and touching each side of the person's spinal column.

### FIELD OF INVENTION

The invention allows the user to avoid using “fixed in place” devices, avoid going to a gym, and avoid using a medical professional and other inconvenient methods of obtaining therapy. The device is portable and can easily be carried on trips or to any alternate locations.

### PRIOR ART

Our research of the prior art in addition to US Patents cited in the “Background of the Invention” section include patents as listed from 1991 through 2006 and includes patent application publications (U.S. 2006/0235743 A1 of Oct. 19, 2006 and U.S. 2011/0021959 A1 of Jun. 27, 2011). These all suffer from various deficiencies such as size, weight, higher costs, lack of portability, cumbersome use and other restrictive factors.

Nothing in the prior art contains all the designs and features of this invention. and does not suggest the concept of this invention by any person skilled in the art.

This invention (device and method of application) is similar, yet distinctly different from a number of other inventions involving massage devices and methods wherein the user rests his/her back against the device with or without the device being sandwiched between the user's back and a flat firm surface. One such device and means of use is U.S. Pat. No. 4,274,519 issued Feb. 22, 1983. However there is no provision in this or other patents for the complete flexibility and control of use by the user. Other devices, while capable of self-use, such as U.S. Pat. No. 4,493,315 filed Jan. 11, 1985 rely solely on applied pressure by the user's arms and shoulders.

Still, other devices, which utilize a roller principle, do not have sufficient portability, as an example, U.S. Pat. No. 44,606,509 filed Aug. 19, 1986.

Another device while similar in use so far as hands and arms does not provide for a means of applying and adjusting pressure by the user according to his needs because there is no flat surface in that reference U.S. Pat. No. 5,848,980 filed Dec. 15, 1998.

### BACKGROUND OF THE INVENTION

This invention (device and method of application) is similar, yet distinctly different from a number of other inventions involving massage devices and methods wherein the user rests his/her back against the device with or without the device being sandwiched between the user's back and a flat firm surface. One such device and means of use is discussed in the prior art section, U.S. Pat. No. 4,274,519 issued Feb. 22, 1983. However there is no provision in this or other patents for the complete flexibility and control of use by the user.

Other devices, while capable of self-use, such as U.S. Pat. No. 4,493,315 filed Jan. 11, 1985 rely solely on applied pressure by the user's arms and shoulders.

Still other devices, which utilize a roller principle, do not have sufficient portability, as an example, U.S. Pat. No. 44,606,509 filed Aug. 19, 1986.

Another device while similar in use so far as hands and arms does not provide for a means of applying and adjusting pressure by the user according to his needs because there is no flat surface in that reference U.S. Pat. No. 5,848,980 filed Dec. 15, 1998.

### SUMMARY OF THE INVENTION

A massaging and exercising device and method of self-use by the person in need who has existing or recurring back problems or is in need of preventing aggravation to the person's back caused by the spine and numerous associated muscles surrounding the spine is described fully herein.

The device is small, lightweight and very portable allowing the user to hand carry it in a briefcase, travel bag, etc. The method of use is applied by the person whose back needs massage and the device is preferably held by the user's two hands and force applied by the user's body leaning against a wall or any flat surface either vertical, horizontal or on an angle in between. The user will use his legs bending at the knees and moving his torso up and down on his toes.

There is no mounting or permanent attachment needed although it would be obvious to one skilled in the art to hang the device from a ceiling, etc. if the user had limited use of his/her arms or hands by a physical partial restriction.

### DESCRIPTION OF DRAWINGS

The drawings included illustrate the device, its position on the user and the dimensions (general and specifically preferred).

FIG. 1—Basic Device—Basic Elements of the Device in total (1 is the metal rod; 2 are the small balls; 3 are the large balls; 4 are the ends of the straps that rod can rotate through; 5 are the end of straps fixed to the rod; 6 are the straps; 7 and 8 are means to grip by the hands

FIG. 2—User Positions—Overview of the user, the device and the various positions in use

FIG. 3—Strap Lengths—Shows various lengths of straps

FIG. 4—User with Device—Shows the device over the shoulders of a typical user

FIG. 5—Device Positions and FIG. 6—Device User Positions—show the device in various positions by a user

FIG. 7—User-Wall-Legs-Toes—shows the user against a flat wall with knees bent and on toes

FIG. 8—Buttocks Position—shows the device in a typical use and also in use on the buttocks area

### DETAILED DESCRIPTION OF THE INVENTION

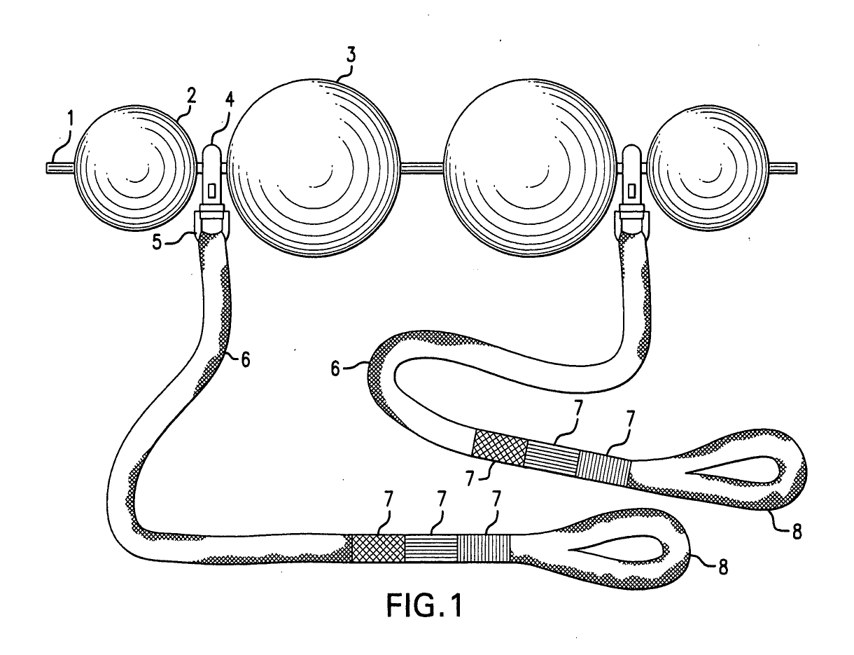

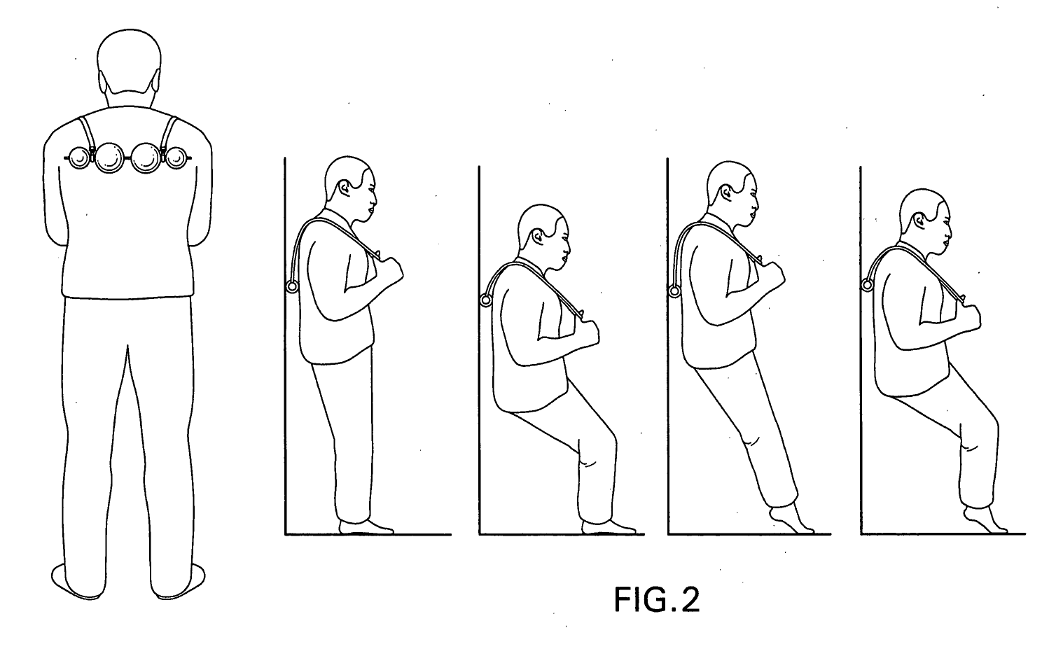

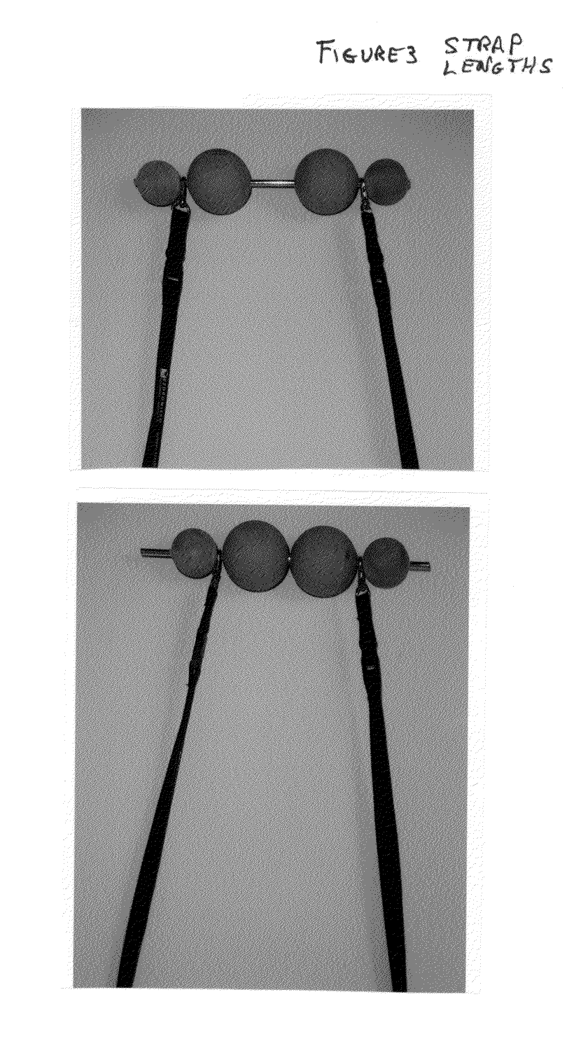

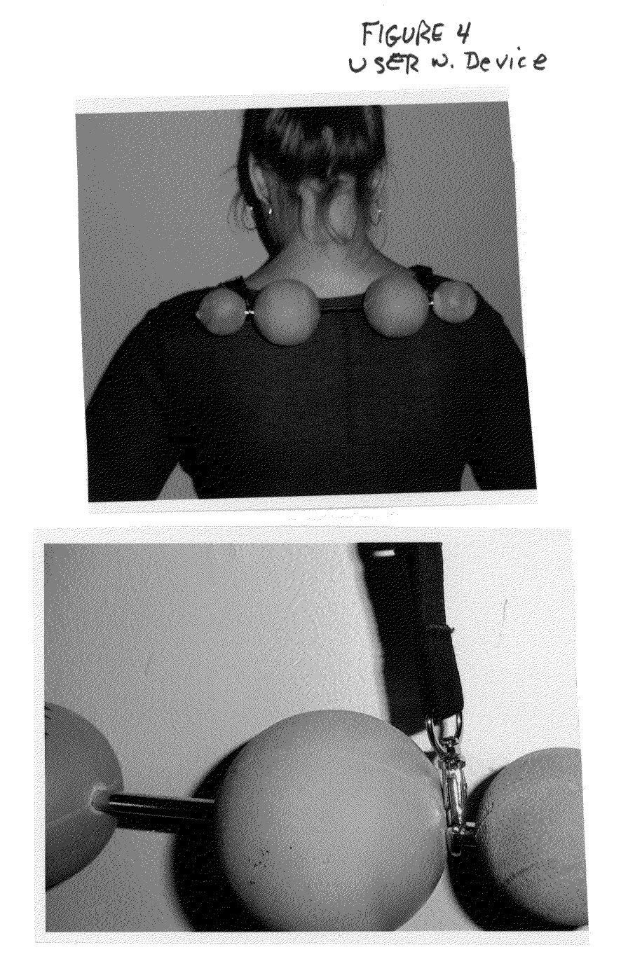

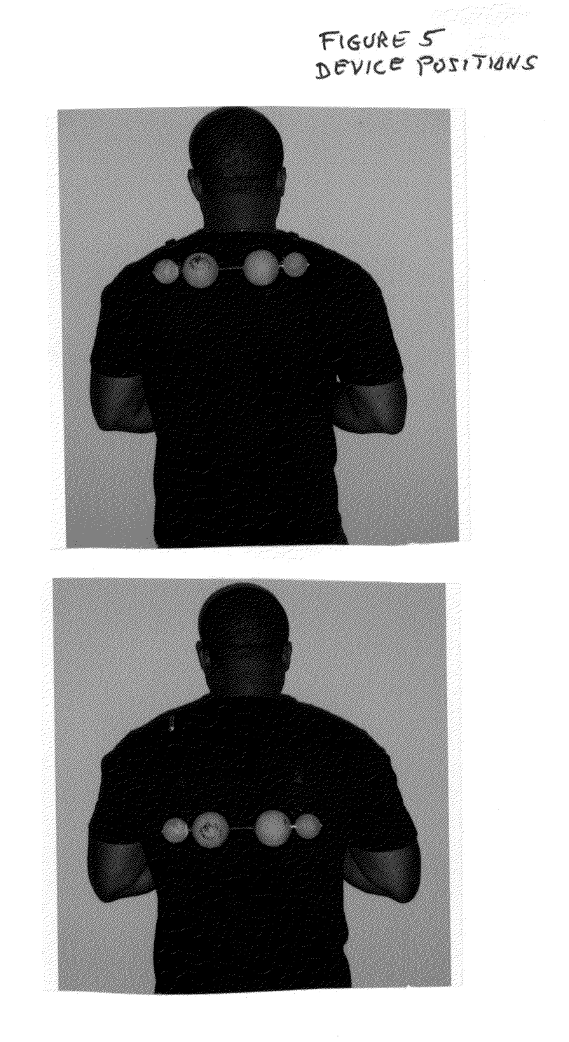

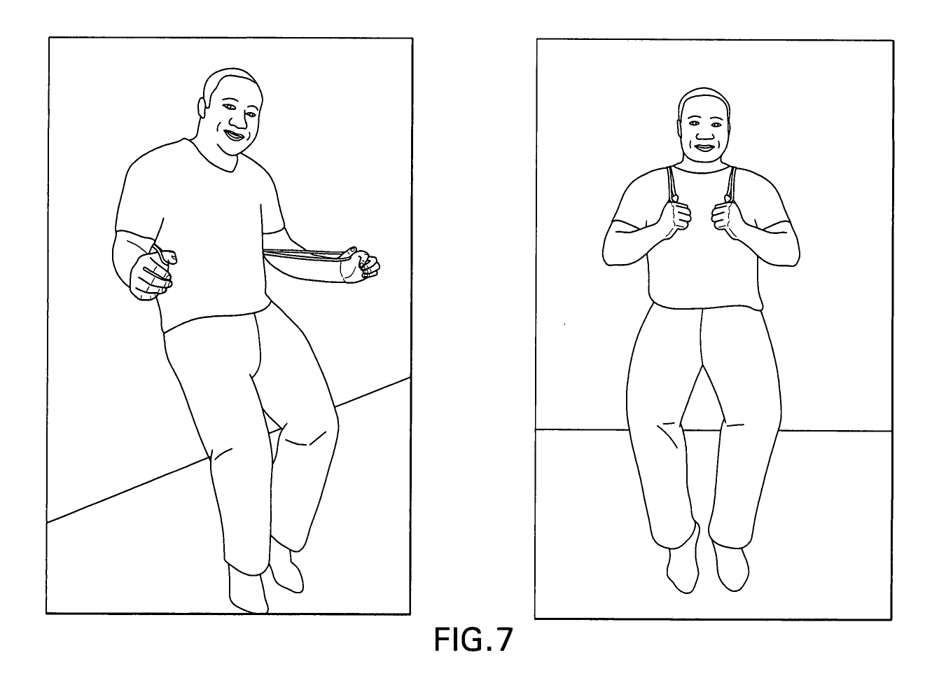

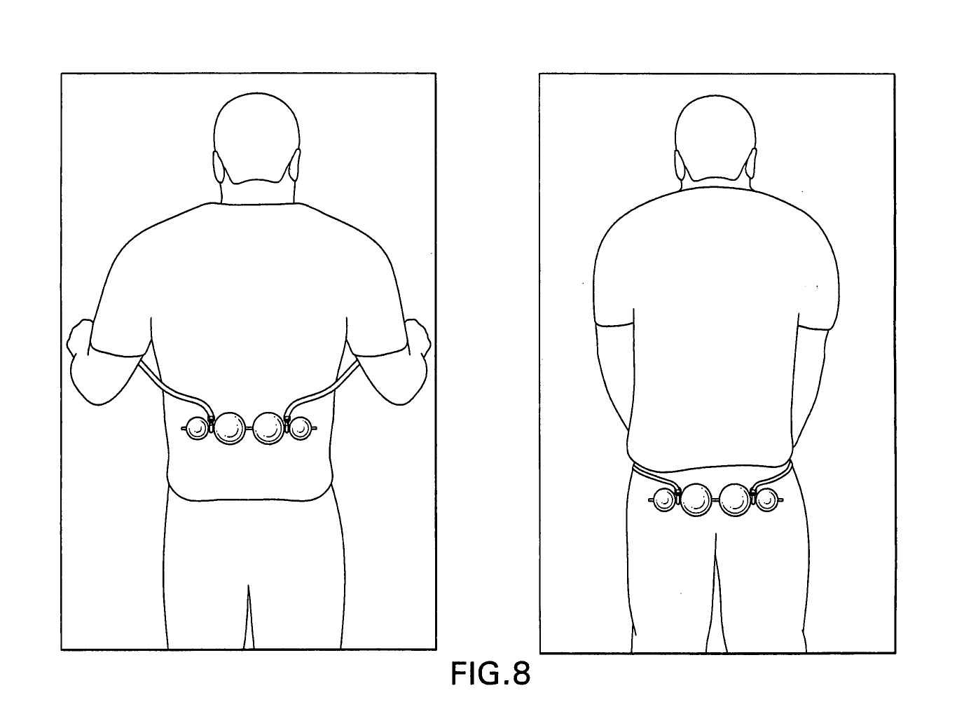

The device (FIG. 1) described specifically in claims 1,2,3,4 and claim 5 is optimally used by the person whose back (and/or buttocks (FIG. 8)) require treatment. The person grips each strap with each hand and flips the device over his/her head and shoulders (FIG. 2) and positions it about mid-back. The user then leans against a wall with his/her torso on a slight incline (say 30 degrees form the vertical) and legs bent slightly at the knees (FIGS. 2 and 7).

From this position, the user can apply some pressure from his/her body weight to the device pressing it between his/her back and the wall. The user can then move his/her torso up and down vertically and stepping on his toes (the legs will allow bending at the knees (FIG. 7)). For example, we refer to this as the use with the device in an horizontal position and the motion of use as vertical or up and down the back. The “trigger points” are well contacted in this manner.

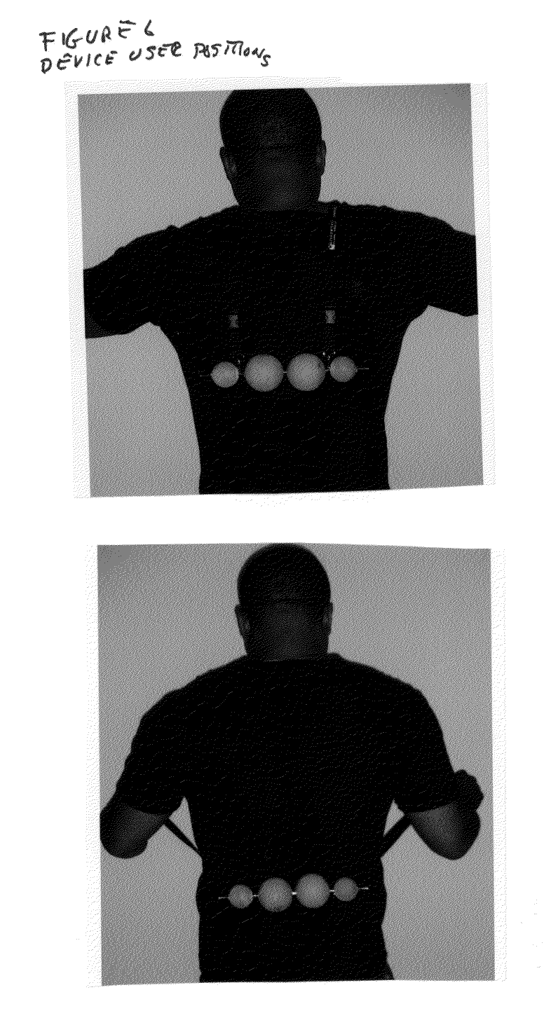

The two larger, interior main balls can be further adjusted to be at various distances on either side of the spine (FIGS. 5 and 6) essentially on muscles that are adjacent to the spinal column. They would typically be offset from the center of the spine and judged comfortable and in the right place by a natural feeling of the user.

The self-user can adjust his/her pressure and movement to get the most beneficial effect from the devices massage application. Anyone who has had a massage or therapy from a medical professional knows the best feelings that provides effective treatment whether the masseuse has used their hands or balls on a mat or cloth, etc. Another example of use is the position of the device as vertical and the pressure applied horizontally because the user would have one strap over the shoulder and the other pulled around his side.

The device has a very excellent utility value by virtue of its inherent size, weight, portability and readily available parts at very low prices. Assembly can be easily accomplished by an individual or lower skilled workers in a light manufacturing business thus allowing both a low cost and a low selling price.

Various manufacturers who might license this device from the inventor under this patent can claim additional benefits from developing special pricing or by virtue of defining special balls with enhanced properties proven by example or by developing straps that have easier grips or means of adjustment for heights and sizes of various users.

These further improvements and features would be obvious to those skilled in the art of design and manufacture.

I claim:

1. A lightweight massage device (approximately 0.5 pounds) comprising:
a) a fixed and firm metal or thermosetting plastic rod approximately 12 inches long and between ¼ to ¾ inches in diameter
b) two semi-compressible balls (between 1 to 3 inches in diameter) made of a rubber or plastic or composite material with a high coefficient of restitution material with a hole drilled through a diameter line that allows the rod to pass through the balls and the balls to rotate with the rod
c) two or more smaller balls each on one side of the larger balls drilled in a similar fashion to serve the purpose of adding some weight and stability to the device and these balls do not necessarily have to touch the person's back.
d) two straps attached to the firm rod near each end and such that the rod can rotate freely within the strap ends and so that the other end can be held with a hand
e) the use of any flat surface that allows the whole device to be rolled against as pressure is applied to the back.

2. The device of claim 1 with more than two balls in even number such that more contact is made with the muscles of the back and the flat surface.

3. The device of claim 1 where the straps are of adjustable length for users of different height.

4. The device of claim 1 with grips placed on the straps for easier and firmer holding by the user.

5. A device of claim 1's general features but specifically using
a) a ¼ inch diameter firm rod of 11 inch length
b) two balls of three inch diameter with a ¼ inch drilled hole through a diameter line so that the rod can be passed through the balls and the balls can rotate with the rod
c) two smaller balls of 1.5 inch diameter one each placed on either side of the two larger balls with ¼ inch diameter holes drilled through these smaller balls such that the rod can pass through on a diameter line
d) all the balls are movable along the axis of the rod for specific positioning symmetrically along the rod and perpendicular to the spinal column and with the center of the rod essentially lined up with the spinal column
e) two straps about ½ inch wide so as to be comfortable when one end is held by the user' hands laying over the user's shoulders and the other ends are firmly fastened to the rod.

6. A method of using the devices of claims 1,2,3,4 and 5 such that the user flips the device over his head and shoulders while holding the straps, positioning the balls and rod so that the device can roll up and down the back and massage the muscles on both sides of the spinal column by their action as the user presses against the wall with his/her body and moves his/her torso up and down to massage muscles along the entire length of the spinal column or concentrating local up and down motion in an area needed the most by subjective judgment of the user.

7. A method of using the devices of claims 1,2,3,4 and 5 such that the straps are long enough for the balls and rod to be resting on the buttocks and the buttocks are massaged and the user can provide some pressure against the flat surface or simply pull tighter on the straps without contacting a flat surface if held in a horizontal position instead of over the shoulders.

8. A method of using the device of claims 1,2,3,4 and 5 with the flat surface being a floor and the user using his/her weight as pressure and bent legs for adjustment and applying motion along the line parallel to the spinal column and parallel to the floor.

9. A method of using the device whereby the straps are hung from a ceiling or other attachment to a wall such that the arms and hands do not have to be fully used due to some physical impairment of the user but the height of the fixed rod (parallel to the floor) is about mid-back and the user still makes vertical motions to move the device up and down the spine.
